(19) United States
(12) Patent Application Publication
(10) Pub. No.: US 2010/0116922 A1
(43) Pub. Date: May 13, 2010

(54) CABLE REEL LOCK FOR FALL ARRESTOR

(75) Inventors: Gary E. Choate, Lakewood, CO (US); Wayne L. Olson, Central Point, OR (US)

Correspondence Address: Polster, Lieder, Woodruff & Lucchesi, L.C., 12412 Powerscourt Dr. Suite 200, St. Louis, MO, 63131-3615, US

(73) Assignee: RELIANCE INDUSTRIES, LLC, Wheat Ridge, CO (US)

(21) Appl. No.: 12/617,517

(22) Filed: Nov. 12, 2009

Related U.S. Application Data
(60) Provisional application No. 61/199,122, filed on Nov. 13, 2008.

(51) Int. Cl. A62B 35/04; B65H 75/48; B65H 75/30

(52) U.S. Cl. 242/384.7

(57) ABSTRACT

A retractable lifeline comprises a housing a drum rotationally mounted in said space and a lanyard wound about said drum. The lanyard extends from the housing and is extendable from said housing and retractable into said housing. The retractable lifeline further includes a lock assembly to prevent rotation of said drum, and hence extension or retraction of said lanyard, when said lanyard is at a desired length, and an override of the lock mechanism in case of a fall so that the retractable internal shock absorption and clutch mechanism can arrest the fall.

### CROSS-REFERENCE TO RELATED APPLICATIONS

This application claims priority to Provisional Application No. 61/199,122 filed Nov. 13, 2008 and which is incorporated herein by reference.

### STATEMENT REGARDING FEDERALLY SPONSORED RESEARCH OR DEVELOPMENT

Not Applicable.

### BACKGROUND OF THE INVENTION

This application discloses a cable reel lock for a fall arrestor which enables workers doing leading edge work on elevated structures to secure their location at fixed distances from their anchorage and still be provided with energy absorbing fall arrest protection, as well as a method of using the cable reel lock.

Fall protection anchorage devices are used for worker safety in many industrial applications to provide fall protection for workers working at heights. There are generally two types of fall protection anchorage devices, both of which attach to the dorsal D-ring of a worker's harness. The first type of device is a sewn webbing lanyard that uses (tear-away) webbing that rips apart during a fall arrest to provide the worker with a “soft stop” by limiting the fall arrest forces to no more than 900 lbs (4000 N) and the deceleration distance to no more than 42″ (˜1 m). These devices are generally less expensive but limit the worker's mobility to no more than 6 ft (˜1.8 m) from his anchor point

The second type of anchorage device used for fail arrest is referred to as a retractable lifeline. These devices are comprised of a drum reel containing lanyard which can be made from wire cable or rope, synthetic cable or rope, or synthetic webbing. These devices normally are produced in sizes that range from 6 ft to 120 ft (˜1.8 m to ˜36.6 m). For this reason they provide the worker with a much greater range of mobility.

While most fall arrest anchorage devices are physically located above the worker's work area and provide for fall arrest in a vertical fall, retractable lifelines enable a worker, when working on a horizontal surface such as a rooftop, to reach the roof edge. Should the worker fall at this position the lanyard (whether steel cable or webbing) will be pulled across the roof edge causing it to not only bend sharply but be subjected to sharp cutting edges while under fall arrest loading. Testing in the United States and Europe has shown that many commonly used roof edges will cut, fray, or significantly weaken the retractable lanyard sufficiently to make it unsafe for fall arrest use.

To address this problem, a new line of “leading edge” retractable lifelines have been designed and tested for use in these applications. Most significantly, testing has shown that the lanyards used in these devices must be increased about 30% in diameter to carry the intended loads. Secondly, a lock mechanism has been added to the cable reel to enable the worker to limit the cable extraction at any location to prevent him from reaching the leading edge. By locking the cable at any length from his anchorage the worker can use the cable as a work-positioning device preventing him from overreaching the leading edge thus preventing the onset of a fall. This lock device, however, must not prevent the shock absorber in the retractable from working in case of an accidental fall. For this reason the lock mechanism must be able to be unlocked manually by the worker and yet it must be overridden automatically in case a fall occurs. The following description provides details of preferred embodiments of such an invention.

### BRIEF SUMMARY OF THE INVENTION

An improved retractable lifeline is disclosed for use as a leading edge retractable lifeline that will enable a worker to use a retractable lifeline as a travel restriction device without overriding the internal shock absorption available in a retractable lifeline. The retractable lifeline allows the worker to manually lock the retractable reel of the retractable lifeline at any location that will provide the correct lanyard length to keep the worker from overreaching his workspace leading edge, thus creating the potential for an accidental fall.

Briefly stated, the retractable lifeline comprises a housing having a front portion and a back portion; each the portion comprising a surface and a wall. The front and back portions define a hollow space when joined together and an exit from the hollow space. A drum is rotationally mounted inside the housing and a lanyard is wound about the drum. The lanyard can be extracted from the housing to lengthen the exposed portion of the lanyard and retracted into the housing.

The retractable lifeline further includes a locking assembly which is selectively movable between a locked position and an unlocked position. In the locked position, the drum cannot rotate, and hence the lanyard can not be extended from, or retracted into, the housing. In the unlocked position, the drum is free to rotate, and hence, the lanyard can be both extended from and retracted into the housing. The lifeline further includes a release which will automatically release the lifeline from the locked position to allow the drum to rotate when more than a determined amount of force is applied to the lanyard.

The locking assembly comprises a ring gear rotationally fixed to the drum, a pinion gear mounted in the housing, and a shaft to which one of the ring gear and pinion gear are rotationally fixed. The shaft is selectively movable axially between a first locked position in which the ring gear and the pinion gear are engaged and a second unlocked position in which the ring gear and pinion gear are not engaged. The locking assembly further includes a mechanism for prevention rotation of the shaft at least when the shaft is in the first locked position to prevent rotation of the drum when the locking assembly is in the locked position.

The mechanism for preventing rotation of the shaft (and hence of the drum) comprises a protrusion extending from the shaft which engages the housing to prevent rotation of the shaft relative to the housing at least when the shaft is in the first locking position. However, the protrusion automatically disengages the housing when more than a predetermined amount of force is applied to the lanyard to allow the drum to rotate. In an illustrative example, the protrusion comprises a shear pin which extends from the shaft. In this example, the housing includes at least a lock slot which receives the shear pin. When the shear pin is engaged in the slot retaining the shaft in the first locked position; the shear pin being sized and shaped to break when more than the predetermined force is applied to the lanyard. In a preferred embodiment, the housing comprises two intersecting slots, the slots being of different depths, whereby when the shear pin is in one slot, the shaft is in the first locking position and when the shear pin is in the second slot, the shaft is in the second unlocked position. The two slots can, for example, be formed on a boss extending from the housing surface.

The retractable lifeline allows the worker to unlock, reposition, and re-lock the cable reel at any desired location. Further, the lifeline provides for an override of the lock mechanism in case of a fall so that the retractable internal shock absorption and clutch mechanism can arrest the fall.

### BRIEF DESCRIPTION OF THE SEVERAL VIEWS OF THE DRAWINGS

FIG. 1 is a perspective view of a leading edge retractable lifeline;

FIGS. 2A-C are plan, cross-sectional and perspective views, respectively, (with the housing back portion, drum and lanyard omitted from FIG. 2C for purposes of illustration) showing retractable lifeline device in a locked position to prevent extension and retraction of the lifeline lanyard;

FIGS. 3A-C are plan, cross-sectional and perspective view, respectively, (with the housing back portion, drum and lanyard omitted for purposes of illustration) showing retractable lifeline device in an unlocked position to allow for extension and retraction of the lifeline lanyard with the drum and ;

FIG. 4 is a detail of drum and pinion gears showing the gears in an engaged position;

FIG. 5 is a detail of the weld boss showing the different lock groove depths for holding the shear pin;

FIG. 6 is a detail of the pinion and reel gears showing the engagement spring that hold the gears in engagement;

FIG. 7 shows a detail of the handle assembly with the shear pin and engagement spring;

FIGS. 8A and 8B are cross-sectional views of the retractable life line in locked and unlocked positions, respectively, with an alternative handle assembly; and

FIGS. 9A and 9B are enlarged cross-sectional views of the handle assemblies of the lifelines of FIGS. 8A and 8B, respectively.

Corresponding reference numerals will be used throughout the several figures of the drawings.

### DETAILED DESCRIPTION OF THE INVENTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what we presently believe is the best mode of carrying out the invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

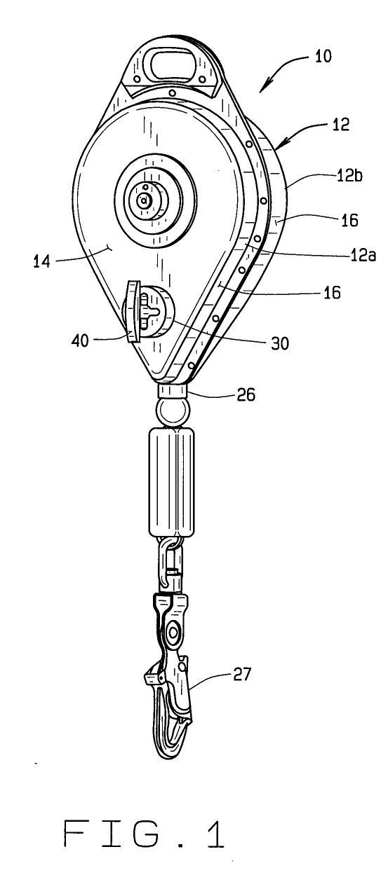

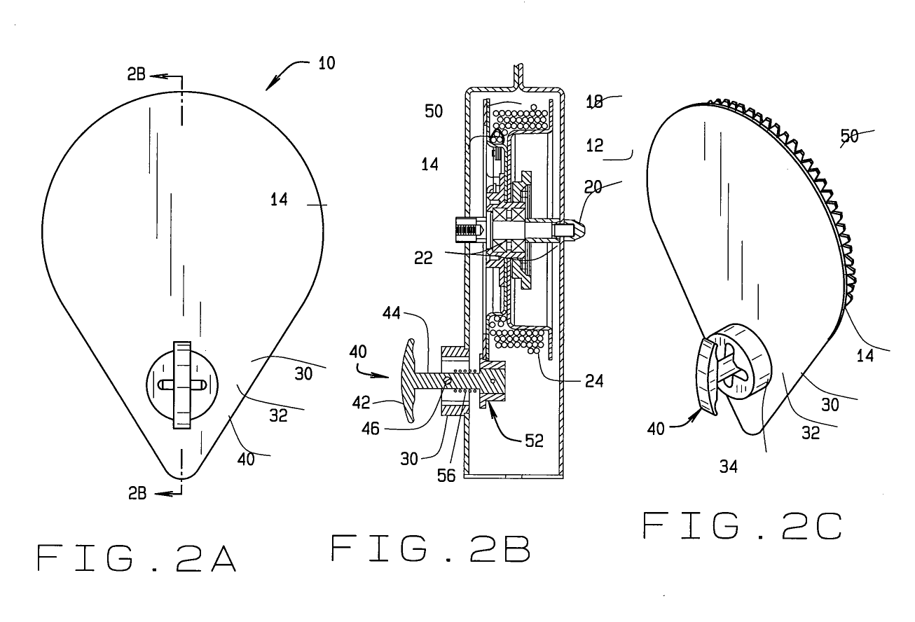

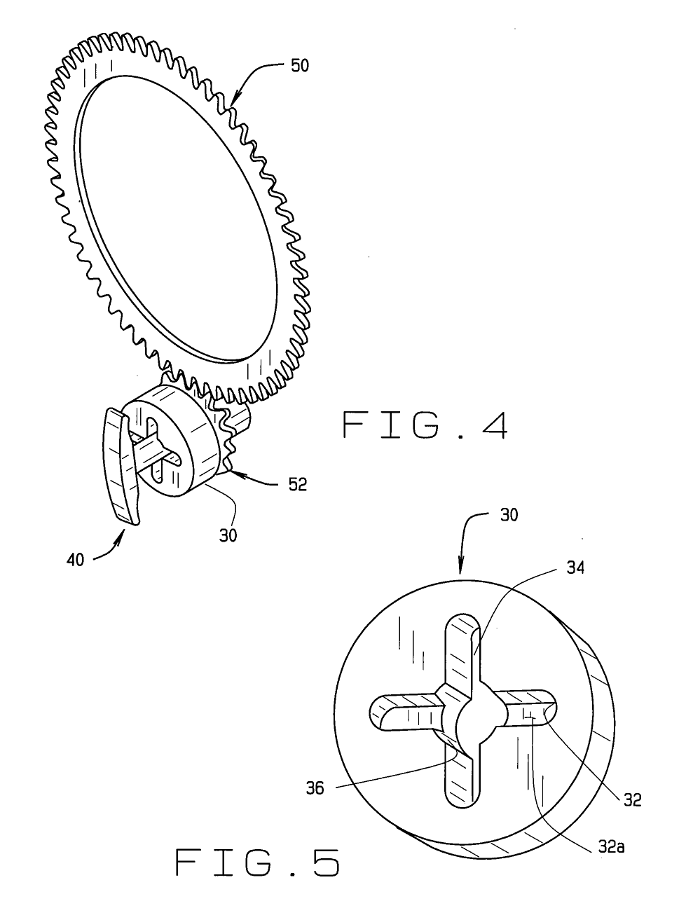

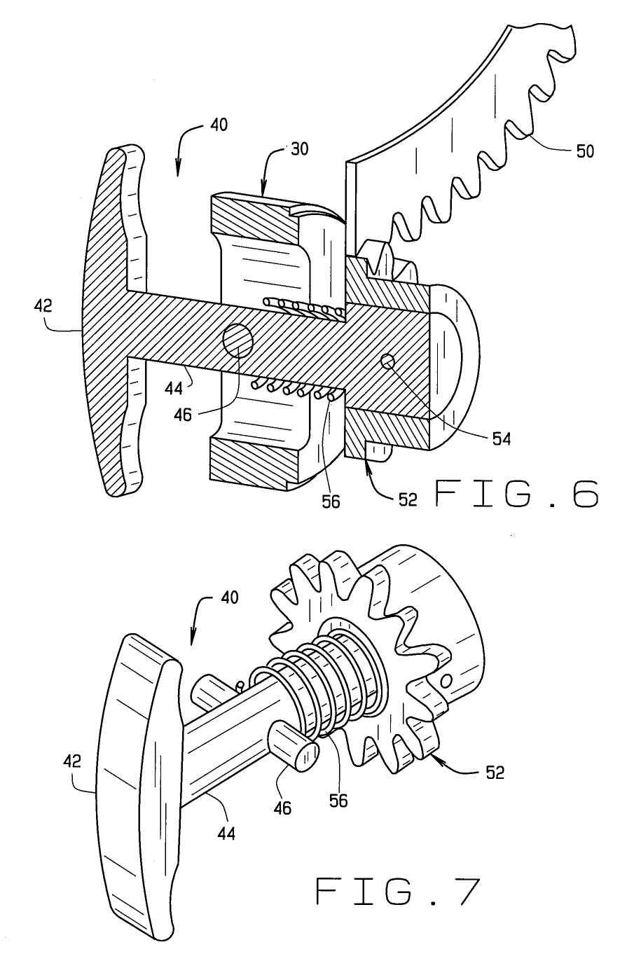

A retractable lifeline device 10 is shown generally in FIG. 1 and in more detail in FIGS. 2-7. The retractable lifeline device 10 comprises a housing 12 comprised of a front portion 12a and a back portion 12b. As seen, the housing is generally tear- or pear-shaped. The front and back portions each have wall surfaces 14 and walls 16. When the front and back portions are joined together, the surfaces 14 and walls 16 of the front and back portions define a hollow space in which a drum 18 is rotatably mounted. The drum, for example, can be mounted about an axle 20 which extends between the front and back portions. Bearings 22 can be positioned between the drum and the axle to facilitate rotation of the drum about the axle. A lanyard 24 is wound about the drum. As is known, the lanyard extends through an exit 26 in the bottom of the housing 12. A clip 27 is mounted to the end of the lanyard to allow the lanyard to be connected to the D-ring of worker's harness. As is standard, a spring element (not shown) is provided so that the drum will automatically rotate when tension on the lanyard is reduced to retract the lanyard into the housing and about the drum.

A boss 30 extends form the surface 14 of the housing front portion 12a near the bottom of the housing 12. The boss 30, as seen best in FIG. 5, comprises two intersecting slots 32 and 34 with a circular hole 36 at the intersection of the two slots. The first slot 32 is shallower than the second slot 34 and includes a floor 32a. The second slot 34 and the hole 36 are both shown to extend through the boss 30.

A handle 40 (shown in FIGS. 1 and 6-7 as T-handle) comprises a grip 42 which is connected to a shaft 44. The shaft 44 is sized to pass through, and rotate in, the hole 36 of the boss 30. A shear pin 46 extends through the shaft 44 and is generally perpendicular to the shaft 44. The shear pin 46 has a length greater than the diameter of the boss hole 36, but less than the length of the boss slots 32, 34, such that the pin can be received in the slots. The shear pin is designed to shear when rotational or other shear forces greater than 400 lbs (˜1780 N) are applied to the pin.

Internally of the housing 12, the retractable lifeline 10 comprises a ring gear 50 fixed (or operatively fixed) to the drum to rotate with the drum 18. Additionally, a locking gear 52 (such as a pinion gear) is rotationally fixed to the end of the handle shaft 44. A pin 54 can extend through the body of the pinion gear 52 and the shaft 44 to rotationally fix the pinion gear 52 to the shaft 44. The ring gear 50 and the drum are positionally or axially fixed relative to the housing. However, the handle 40, and hence the pinion gear 52 can translate axially relative to the housing. Hence, the pinion gear 52 can be moved into and out of engagement with the ring gear 50.

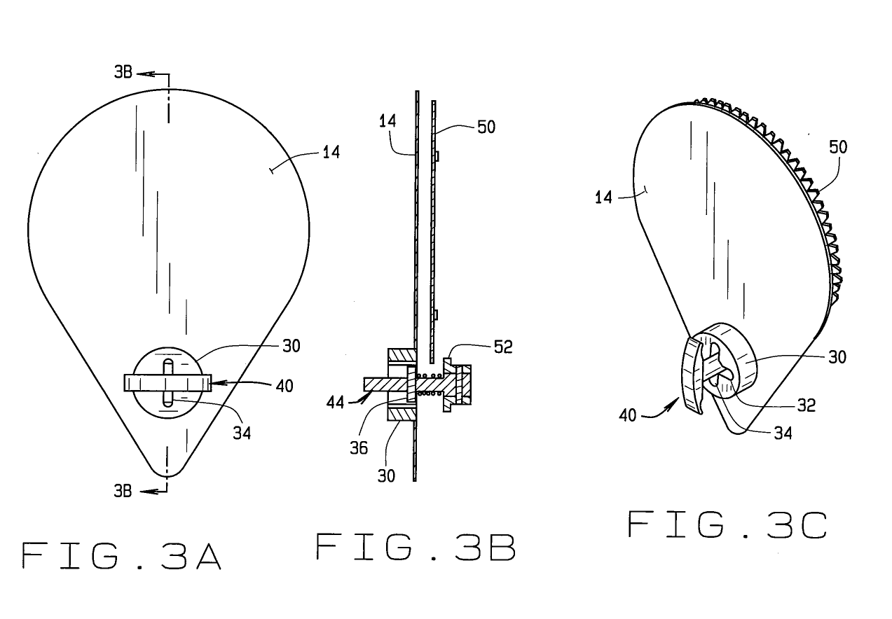

When the shear pin 46 of the handle shaft 44 is received in the shallower slot 32, the pinion gear 52 will be in engagement with the drum gear 50, as seen in FIG. 2B. In this position, the engagement of the pinion gear with the drum gear will prevent the drum from rotating, and the lanyard will be fixed at a determined length—that is, with the pinion and drum gears engaged, the drum will not be able to rotate about the axle 20 and the lanyard 24 will not be able to be extended or retracted. However, when the handle 40 is rotated so that the shear pin 46 is received in the deeper slot 34, the pinion gear 52 will be out of engagement with the drum gear 50, as seen in FIG. 3B. In this unlocked position, the drum 18 is free to rotate about the axle 20, and hence, the lanyard 24 can be extended and retracted as a worker moves about. A biasing element 56 is positioned between an inner surface of the boss 30 and the pinion gear 52 to urge the pinion gear inwardly relative to the housing. The biasing element 56 comprises a coil spring which, as shown, can extend into a cavity in the boss 30. The end of the spring opposite the pinion gear can engage a surface of the boss, such as a surface opposite the floor 32a of the slot 32. Alternatively, the end of the spring could bear against an inner surface of the housing front portion 14.

Under normal operation the handle 40 is positioned with the shear pin in the unlocked slot 34 so that the retractable lifeline device 10 is allowed to extend and retract the cable lanyard as the worker moves about the work area. When the worker reaches a leading edge that poses a fall hazard, the worker has the option to engage the reel lock which will cause the unit to function as a travel restrictor. It also enables him to lean against the cable if needed for balance or support. Once reaching a leading edge, the worker can then lock the cable reel by pulling the handle 40 outwardly relative to the housing front surface 14 and rotating the handle until the shear pin is aligned with the locking slot 32. The worker can then release to handle 40 so that the shear pin will be received in the locking slot 32. By pulling the handle outwardly, the worker has brought the pinion gear 52 into engagement with the drum gear 50.

With the drum gear 50 locked in position the worker can pull against the retractable lifeline device 10 without the lanyard being able to extract. This enables the worker to establish a stable work position by leaning against the retractable anchorage. Should the worker fall in this position with the drum gear 50 locked in place it will cause a rotating load to be transferred to the pinion gear 52 and thereby to the shear pin 46. The shear pin 46 is sized so that the pin will shear when a load greater than 400 lb (˜1780 N) is applied. When the pin shears, there will be nothing preventing the handle shaft 46 from moving axially, and hence nothing holding the pinion gear 52 in engagement with the drum gear 50. Hence, the biasing element 56 will push the pinion gear 52 out of engagement with the drum gear 50, allowing for the drum gear 50 and drum 18 to rotate. This then allows the retractable inner shock absorber to engage ensuring a fall arrest force on the worker. Preferably, the fall arrest force does not exceed 900 lbs (˜400 N).

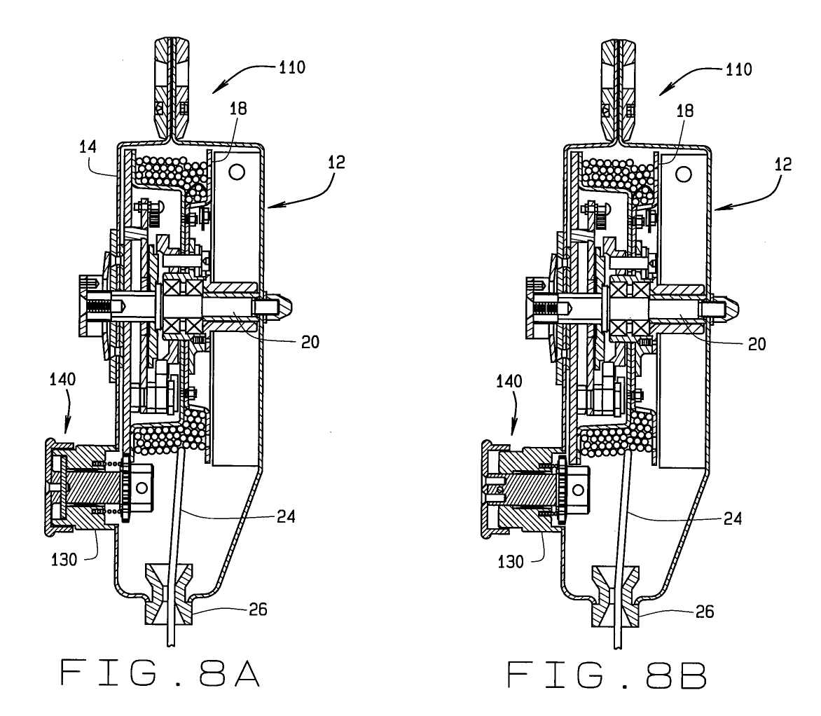

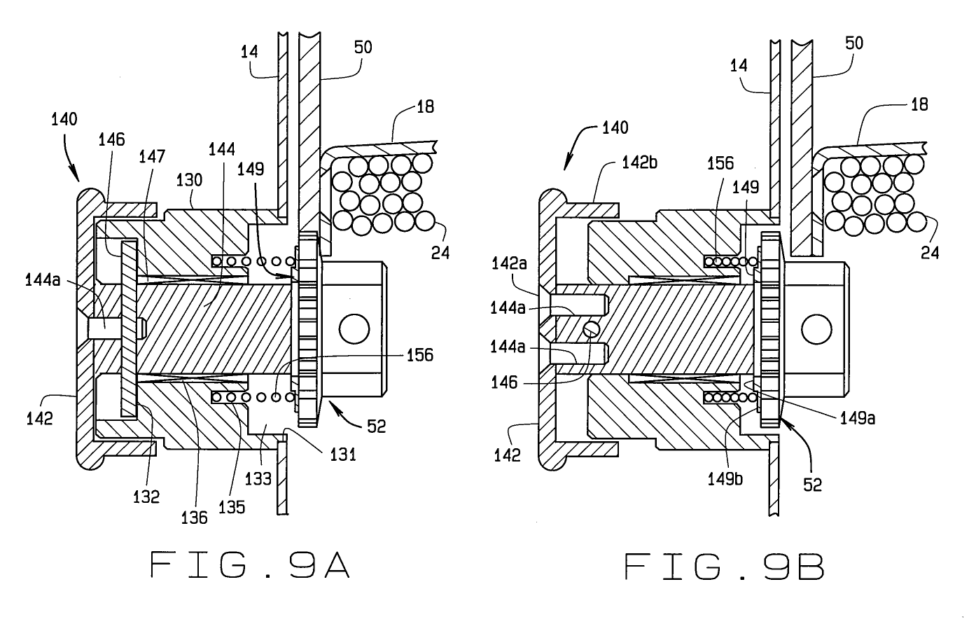

Turning to FIGS. 8A-9B, a retractable lifeline assembly 110 is shown with an alternative boss and handle assembly. The lifeline assembly 110 is substantially the same as the lifeline assembly 10 (FIGS. 1-7), and hence, the same reference numbers will be used to identify identical parts. The parts that are different will be preceded with a “1” (hence, “10” became “110). The lifeline assembly 110 includes a housing 12 containing a drum 18 rotatable about an axle 20. A lanyard 24 is wound around the drum and exits the housing 12 via an exit 26 at the bottom of the housing.

Turning to FIGS. 9A and B, the boss 130 extends from the front portion 14 of the housing 12. As seen, the boss 130 is a separate piece, and is securely welded into place over an opening 131 in the housing front portion 14. The boss 130, like the boss 30, comprises a pair of intersecting slots on an outer side of the boss, with one slot being deeper than the other, and a bore 136. The locking slot 132 is shown in FIG. 9A. On an inner side, the boss 130 includes a cavity 133 which opens into the inside of the housing 12. An annular channel 135 extends outwardly from a surface of the cavity 133.

A shaft 144 extends through the bore 136 of the boss 130, and the pinion gear 52 is mounted to an inner end of the shaft 144. A shear pin 146 extends through the shaft 144 substantially normal to the shaft, and is sized and shaped to be received in the two slots of the boss 130, in the same manner as the shear pin 46. The bore 136 is wider than the shaft 144, and a bearing 147, such as a journal bearing, is received in the bore 136 through which the shaft 144 extends. The bearing 147 maintains the shaft 144 centered with respect to the bore 136 and facilitates rotation of the shaft 144 in the bore 136. A washer 149 is positioned an the surface of the pinion gear 52 facing the shaft 144. The washer 149 has a central platform 149a and a peripheral flange 149b. A coil spring 156 is positioned around the shaft 144, and extends between the pinion gear 152 and the boss 130. One end of the coil spring 156 engages the washer 149 and the opposite end of the coil spring is received in the annular channel 135 in the boss cavity 133. As can be appreciated, the annular channel 135 and the washer 149 maintain the coil spring centered relative to the shaft 144.

Externally, a handle 140 comprising a pull member 142 is secured to the shaft 144, for example, by means of screws which extend through the pull member 142 into screw holes 144a in the shaft 144. The pull member 142 is in the form of a cap comprising an end surface 142a and a side surface 142b, which, in combination, define a circular area that is sized to receive the end of the boss 130, and which can rotate relative to the boss 130.

As noted above, the pull member 142 is fixed to the shaft 144, which in turn is fixed to the pinion gear 52. Thus, by pulling the pull member 142 outwardly, the pinion gear 152 is moved from the position shown in FIG. 9A in which it engages the drum gear 50 to the position shown in FIG. 9B in which it is disengaged from the drum gear. The pinion gear can be held in this position by rotating the pull member 142 such that the shear pin 146 is received in the shallower slot. By pulling the pull member outwardly to the position at which it can be rotated, the handle assembly 140 can be switched to a position in which the shear pin is in the deeper slot, and thus in which the pinion gear and the drum gear are engaged. As can be appreciated, operation of the handle assembly 140 is thus substantially the same as for the handle 40.

As with the life line assembly 10, when the lifeline assembly 110 is in the locked position (as shown in FIGS. 8A and 9A), the drum is prevented from rotating, and the lanyard therefore cannot be extended or retracted. Again, and as with the lifeline assembly 10, if more than a predetermined amount of rotational force or torque (i.e., about 400 lbs or about 1780 N) is applied to the shear pin 146, the shear pin will break. As seen in FIG. 3B, the pinion gear 52 is positioned inwardly of the drum gear 50 (i.e. further from the housing front portion 14) when the lifeline assembly 10 is in the unlocked position. However, as seen in FIG. 9B, the pinion gear 52 is positioned outwardly of the drum gear 50 (i.e., closer to the housing front portion 14) when the lifeline assembly 110 is in the unlocked position. Hence, in the lifeline assembly 110, when the pin 52 in the lifeline assembly 110 shears, there will be nothing preventing the handle shaft 144 from rotating, and hence nothing holding the pinion gear 52 stationary with respect to the housing. Thus, the pinion gear 52, even though still engaged with the drum gear 50, is now free to rotate with the drum gear 50 and the drum 18. This then allows the retractable inner shock absorber to engage ensuring a fall arrest force on the worker. Preferably, the fall arrest force does not exceed 900 lbs (˜400 N).

As can be appreciated, the retractable lifeline provides a mechanism that the worker can use to lock the cable reel at any desired location. This ability to lock the cable reel enables the worker to adjust the retractable lanyard length to prevent the onset of a fail at dangerous locations such as roof edges. This ability to lock the reel also enables the worker to lean against the lanyard for stability such as when leaning out into areas where no other support is provided (such as changing light bulbs in hard to reach areas on the sides of buildings). From one anchorage position for the retractable lifeline, the worker can remain attached while moving and repositioning to new work areas. The locked lanyard line then acts as a travel limiter telling the worker that he has reached the boundary edge even if he is not watching or cannot see his exact position in dim lighting.

As various changes could be made in the above constructions without departing from the scope of the invention, it is intended that all matter contained in the above description or shown in the accompanying drawings shall be interpreted as illustrative and not in a limiting sense. For example, the boss 18 could be provided with a sloped surface having a slot at an upper end of the sloped surface and a stop at the lower end of the sloped surface. The shear pin would ride along the sloped surface as the T-handle is rotated relative to the boss to move the pinion gear into engagement with the drum gear. The slot at the top of the sloped surface would be sufficiently deep to retain the shear pin in the slot against rotational forces which might be applied to the shear pin. As shown and described the pinion gear is in the locking position when the shear pin is received in the shallow slot. However, the position of the pinion gear and/or the drum gear could be altered such that the pinion gear is in the locking position when the pinion gear is in the deep slot. Although the boss extends from the housing, the housing could be constructed such that the slots which receive the shear pin are in the surface of the housing, to present a generally flush surface to the housing. The shear pin could be replaced with spring mounted balls which are then received in detents. The spring mounted balls could be positioned in either the boss hole or the handle shaft, and the detents would be in the opposite of the two. The spring, in this, instance would be sized such that a 400 lb rotational force applied to the spring would cause the ball to disengage the detent, to allow the pinion gear to move from the locked position to the unlocked position. Although the shear pin receiving slots are shown to intersect at right angles, the slots could intersect at alternate angles. Although pinion gear is described to be axially movable relative to the drum or ring gear and the drum gear is axially fixed in place relative to the housing, the retractable lifeline device could be constructed such that the drum, and hence the drum gear, is movable axially relative to the pinion gear, and the pinion gear is fixed axially relative to the housing. In this instance, the drum gear would be moved into and out of engagement with the pinion gear via operation of the T-handle 30 to switch the retractable lifeline 10 between is locked and unlocked positions. These examples are merely illustrative.

1. A retractable lifeline comprising:
a housing having a front portion and a back portion; each said portion comprising a surface and a wall; said front and back portions defining a hollow space when joined together and an exit from said hollow space;
a drum rotationally mounted in said space and including a lanyard wound about said drum; said lanyard extending through said exit to be extended from said housing and retracted into said housing; and
a lock assembly to prevent rotation of said drum, and hence extension or retraction of said lanyard, when said lanyard is at a desired length; said lock assembly comprising:
a ring gear rotationally fixed to said drum;
a boss on said surface of said front portion; said boss defining a first slot, a second slot, and a hole; said slots being formed on an outer surface of said boss and intersecting each other; said hole being at the intersection of said first and second slots; said first and second slots being of different depths;
a shaft extending through said hole of said boss into said hollow space;
said shaft being movable axially and rotationally relative to said boss;
a pin extending from said shaft; said pin being sized and shaped to be received in said first and second slots of said boss;
a pinion gear positionally fixed to an end of said shaft;
wherein said shaft is rotationally and axially movable between a first position in which said pin is received in said first slot and said pinion gear engages said ring gear to prevent rotation of said drum and a second position in which said pin is received in said second slot and said pinion gear does not engage said ring gear to allow said drum to rotate within said housing.

2. The retractable lifeline of claim 1 wherein said pin is a shear pin; whereby when more than a determined amount of force is applied to said shear pin, said shear pin will break.

3. The retractable lifeline of claim 2 wherein, when pin is received in said slots, said pin, and hence said pinion gear is prevented from rotating; and upon breaking of said shear pin breaks, said pinion gear remains substantially engaged with said drum gear, however, said shaft, and hence, said pinion gear are free to rotate.

4. The retractable lifeline of claim 2 comprising a biasing element on said pin; said biasing element being operable to automatically disengage said pinion gear from said ring gear when said shear pin breaks.

5. The retractable lifeline of claim 1 including a grip on an outer end of said shaft.

6. A retractable lifeline comprising:
a housing having a front portion and a back portion; each said portion comprising a surface and a wall; said front and back portions defining a hollow space when joined together and an exit from said hollow space;
a drum rotationally mounted in said space and including a lanyard wound about said drum; said lanyard extending through said exit to be extended from said housing and retracted into said housing; and
a lock assembly to prevent rotation of said drum, and hence extension or retraction of said lanyard, when said lanyard is at a desired length; said lock assembly comprising:
a ring gear rotationally fixed to said drum;
a locking gear in said housing;
a shaft extending through said surface of said housing front portion and into said hollow space; one of said ring gear and said locking gear being rotationally fixed to said shaft; said shaft being movable axially to selectively change the relative position of said ring gear and locking gear relative to each other between a first locking position in which said ring gear and locking gear are engaged to prevent rotation of said drum and a second unlocked position in which said ring gear and locking gear are out of engagement;
a protrusion extending from said shaft and engaging said housing to prevent rotation of said shaft relative to said housing at least when said shaft is in said first locking position; said protrusion automatically disengaging said housing when more than a predetermined amount of force is applied to said lanyard to allow said drum to rotate.

7. The retractable lifeline of claim 6 wherein said protrusion comprises a shear pin extending from said shaft; said housing comprising a lock slot sized and shaped to receive said shear pin; said shear pin when engaged in said slot retaining said shaft in said first locked position; said shear pin being sized and shaped to break when more than said predetermined force is applied to said lanyard.

8. The retractable lifeline of claim 7 wherein said housing comprises a second slot intersecting said lock slot and being sized to receive said shear pin; said lock and second slots being of different depths; whereby when said shear pin is received in said second slot, said shaft is in said second unlocked position.

9. The retractable lifeline of claim 8 wherein said lock and second slots are formed on a surface of said housing.

10. The retractable lifeline of claim 9 wherein said housing comprises a boss extending from said surface of said housing front portion; said boss having a surface; said lock and second slots being formed in said surface of said boss.
a boss on said surface of said front portion; said boss defining a first slot, a second slot, and a hole; said slots being formed on an outer surface of said boss and intersecting each other; said hole being at the intersection of said first and second slots; said first and second slots being of different depths;
a pin extending from said shaft; said pin being sized and shaped to be received in said first and second slots of said boss.

11. A retractable lifeline comprising:
a housing having a front portion and a back portion; each said portion comprising a surface and a wall; said front and back portions defining a hollow space when joined together and an exit from said hollow space;
a drum rotationally mounted in said space and including a lanyard wound about said drum; said lanyard extending through said exit to be extended from said housing and retracted into said housing;
locking means selectively movable between a locked position to prevent rotation of said drum when said lanyard is extended to a desired length and an unlocked position in which said drum can rotate; and
automatic releasing means for allowing rotation of said drum when more than a determined amount of force is applied to said lanyard.

12. The retractable lifeline of claim 11 wherein said locking means comprises:
a ring gear rotationally fixed to said drum, a pinion gear mounted in said housing, and a shaft to which one of said ring gear and pinion gear are rotationally fixed; said shaft being selectively movable between a first locked position in which said ring gear and said pinion gear are engaged and a second unlocked position in which said ring gear and pinion gear are not engaged; and
retaining means for preventing rotation of said shaft, and hence said one of said ring gear and pinion gear, at least when said shaft is in said first locked position.
